(19) United States
(12) Patent Application Publication
(10) Pub. No.: US 2013/0078545 A1
(43) Pub. Date: Mar. 28, 2013

(54) FUEL CELL STACK

(71) Applicants: Seong-Jin An, Yongin-si (KR); Jin-Hwa Lee, Yongin-si (KR); Kah-Young Song, Yongin-si (KR); Yasuki Yoshida, Yongin-si (KR); Hee-Tak Kim, Yongin-si (KR)

(72) Inventors: Seong-Jin An, Yongin-si (KR); Jin-Hwa Lee, Yongin-si (KR); Kah-Young Song, Yongin-si (KR); Yasuki Yoshida, Yongin-si (KR); Hee-Tak Kim, Yongin-si (KR)

(73) Assignee: Samsung SDI Co., Ltd., Yongin-si (KR)

(21) Appl. No.: 13/273,827

(22) Filed: Oct. 14, 2011

(30) Foreign Application Priority Data
Sep. 27, 2011 (KR) 10-2011-0097747

(51) Int. Cl. H01M 8/24

(52) U.S. Cl. 429/455

(57) ABSTRACT

A fuel cell stack is disclosed. The fuel cell stack includes a membrane electrode assembly, separation plates on either side of the membrane electrode assembly, current collectors on either side of the separation plates and configured to electrically convey current to an outside circuit, first and second end plates sandwiching the current collectors and configured to apply a connecting pressure, and manifolds formed to pass through the membrane electrode assembly, at least one of the separation plates, at least one of the current collectors, and at least one of the end plates, the manifolds configured to conduct reaction gas, and cutoff blocks inserted into a portion forming manifolds of the end plates to separate the current collectors and the end plates on a passage in which the reaction gas is circulated.

### CROSS-REFERENCE TO RELATED APPLICATIONS

This application claims priority to and the benefit of Korean Patent Application No. 10-2011-0097747 filed in the Korean Intellectual Property Office on Sep. 27, 2011, the entire contents of which are incorporated herein by reference.

### BACKGROUND

1. Field of the Disclosure

The described technology relates generally to a fuel cell, and more particularly, to a fuel cell stack including a manifold circulating a reaction gas supplied to the fuel cell.

2. Description of the Related Technology

In general, a fuel cell is an apparatus for electrochemically generating electricity using a hydrogen gas and an oxygen gas. More specifically, the fuel cell converts a continuously supplied fuel (hydrogen) and air (oxygen) into electrical energy and heat by an electrochemical reaction. Electric power is generated using an oxidation reaction in an anode and a reduction reaction in a cathode.

Currently, the fuel cell is variously researched and used as an alternative power source and representatively, may be a polymer type fuel cell. The polymer type fuel cell has various advantages of having high output density and high energy conversion efficiency, being able to operate even at low temperatures of 80° C. or less, and being able to down-sized and sealed. As a result, the fuel cell is used as the alternative power source in various fields such as non-polluting vehicles, home electric generator systems, mobile communication equipment, military equipment, medical equipment, and the like.

In the polymer type fuel cell, the output of the electrical energy depends on moving a hydrogen ion through a polymer film. In order that the hydrogen ion easily moves through the polymer film, the polymer film should be hydrated with appropriate water. Accordingly, to hydrate the polymer film, the reaction gas inputted in to the anode and the cathode of the fuel cell is generally humidified. Therefore, a relatively large amount of water is contained in the reaction gas circulating the fuel cell.

The electricity and heat reaction products due to the electrochemical reaction are generated in the fuel cell such that a cooling is required. Accordingly, cooling water may be circulated in the fuel cell. The reaction gas and the cooling water flow in the fuel cell through the manifold formed in the fuel cell via an end plate and a current collector. In this process, when a metallic current collector is exposed to the water, galvanic corrosion may occur in the current collector.

The above information is only for enhancement of understanding of the background of the described technology and therefore it may contain information that does not form the prior art that is already known in this country to a person of ordinary skill in the art.

### SUMMARY OF CERTAIN INVENTIVE ASPECTS

In a first aspect, a fuel cell stack having advantages of a structure capable of preventing a current collector from being corroded by a reaction gas moving through a manifold is provided.

In another aspect, a fuel cell stack is provided. The fuel cell stack includes, for example, a membrane electrode assembly (“MEA”), separation plates sandwiching and contacting both sides of the MEA, current collectors sandwiching both sides of the separation plates, the current collectors configured to conduct electrical energy to an outside circuit, first and second end plates sandwiching opposite sides of the current collectors and configured to apply a connecting pressure to the current collectors, manifolds formed to pass through the MEA, at least one of the separation plates, at least one of the current collectors, and at least one of the end plates, the manifolds configured to fluidly communicate reaction gas, and cutoff blocks inserted into a portion of the end plates forming the manifolds, the cutoff blocks configured to electrically separate the current collectors and the end plates from a passage in which the reaction gas is circulated.

In some embodiments, the current collectors include a cathode current collector adjacent to the first end plate and an anode current collector adjacent to the second end plate. In some embodiments, the cutoff blocks include a first block inserted into the portion forming the manifold of the first end plate and protruding to a portion forming the manifold of the cathode current collector configured to block the contact between the reaction gas and the cathode current collector and a second block inserted into a portion forming the manifold of the anode current collector adjacent to the second end plate configured to block contact between the reaction gas and the anode current collector. In some embodiments, the first block is formed of a non-metallic material. In some embodiments, the first block is formed in a polyhedral or cylinder shape with a through-hole connection with the manifold. In some embodiments, the first block is formed so that a portion protruding to the cathode current collector side is the same as a thickness of the cathode current collector. In some embodiments, the first block is formed of the non-metallic material including synthetic resins or polytetrafluoroethylene (PTFE). In some embodiments, in the first end plate, an insertion part into which the first block is inserted is formed at the portion with the manifold and a gasket is installed between the insertion part and the first block. In some embodiments, the second block contacts the surface of the second end plate. In some embodiments, the second block is formed of a non-metallic material. In some embodiments, the second block is formed of the non-metallic material including synthetic resins or polytetrafluoroethylene (PTFE). In some embodiments, the current collectors include a cathode current collector adjacent to the first end plate and an anode current collector adjacent to the second end plate. In some embodiments, the cutoff blocks include a first block inserted into a portion forming the manifold of the first end plate configured to separate the cathode current collector from the first end plate and a second block inserted into a portion forming the manifold of the anode current collector adjacent to the second end plate configured to block contact between the reaction gas and the anode current collector. In some embodiments, the first block contacts the surface of the cathode current collector.

In another aspect, a cutoff block in a fuel cell stack is provided. The cutoff block is configured to block contact between a current collector and reaction gas in a manifold to prevent the current collector from being corroded due to the water of the reaction gas. In some embodiments, durability of the fuel cell stack is thus improved.

In another aspect, contact between different metals of a current collector and an end plate is blocked by providing a cutoff block in the manifold to prevent the current collector from corrosion. In some embodiments, durability of the fuel cell stack is thus improved.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a perspective view schematically showing a fuel cell stack according to a first exemplary embodiment of the present disclosure.

FIG. 2 is a side view of the fuel cell stack of FIG. 1 viewed from the side.

FIG. 3 is an exploded perspective view of a fuel cell stack according to the first exemplary embodiment of the present disclosure.

FIG. 4 is a cross-sectional view taken along line IV-IV of FIG. 1.

FIG. 5 is a cross-sectional view schematically showing a state in which a first block is installed in a fuel cell stack according to a second exemplary embodiment of the present disclosure.

FIG. 6 is a diagram schematically showing a state in which a first block is inserted into a first end plate according to the second exemplary embodiment of the present disclosure.

FIG. 7 is a side view schematically showing a fuel cell stack according to a third exemplary embodiment of the present disclosure.

### DETAILED DESCRIPTION OF THE INVENTIVE EMBODIMENTS

Hereinafter, a fuel cell stack according to exemplary embodiments of the present disclosure will be described with reference to the accompanying drawings. As those skilled in the art would realize, the described embodiments may be modified in various different ways, all without departing from the spirit or scope of the present disclosure. On the contrary, exemplary embodiments introduced herein are provided to make disclosed contents thorough and complete and sufficient transfer the spirit of the present disclosure to those skilled in the art.

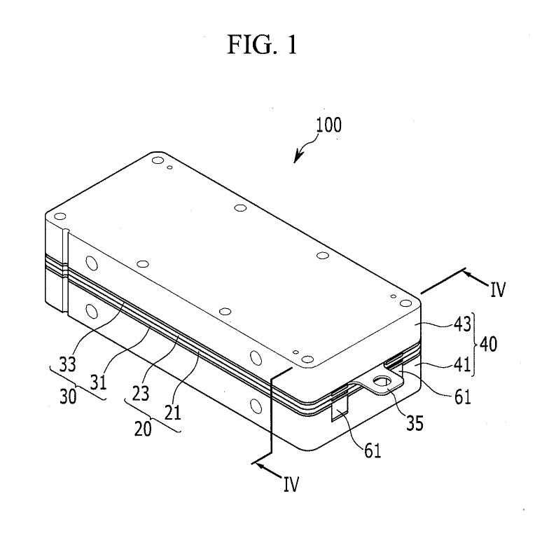

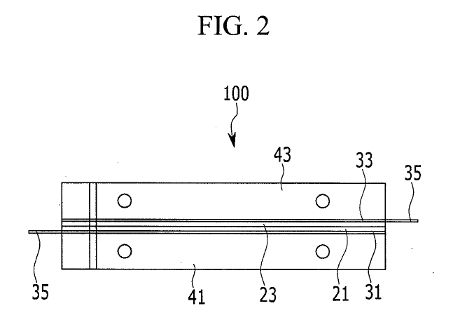

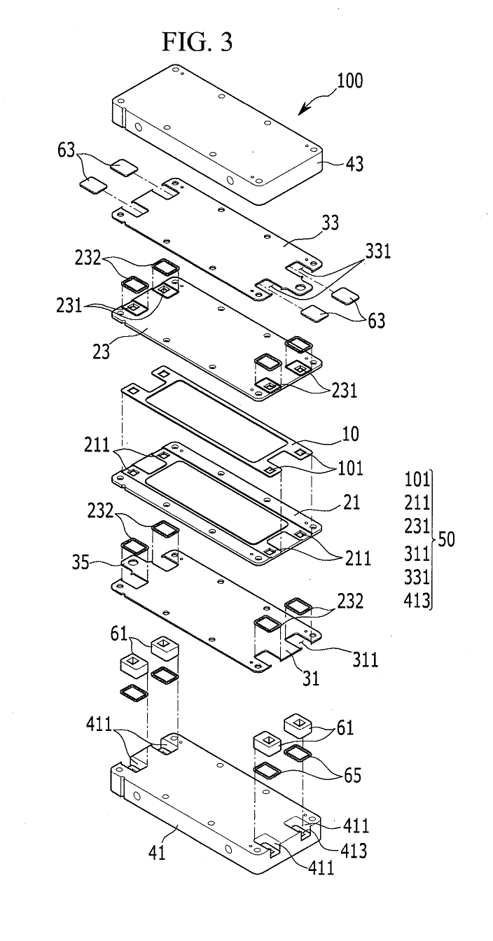

FIG. 1 is a perspective view schematically showing a fuel cell stack according to a first exemplary embodiment of the present disclosure, FIG. 2 is a side view of the fuel cell stack of FIG. 1 viewed from the side, and FIG. 3 is an exploded perspective view of a fuel cell stack according to the first exemplary embodiment of the present disclosure. As shown in FIGS. 1 to 3, a fuel cell stack 100 according to the first exemplary embodiment includes a membrane electrode assembly (MEA) 10, separation plates 20 (21 and 23) contacting both sides of the membrane electrode assembly, current collectors 30 (31 and 33) stacked at both sides of the separation plates 20 (21 and 23) and configured to draw out electrical energy to the outside, end plates 40 (41 and 43) connected at the sides of the current collectors 30 (31 and 33) while applying a connecting pressure, and cutoff blocks 60 (61 and 63) inserted into manifolds 50 (101, 211, 231, 311, 331, and 413) where the reaction gas moves to block a contact between the reaction gas and the current collectors 30 (31 and 33).

The fuel cell stack 100 to be described below means a constituent element configured for generating the electrical energy by electrochemically reacting with hydrogen and oxygen. In the exemplary embodiment, the fuel cell stack 100 exemplifies a unit cell state combined by the membrane electrode assembly 10, a single electricity generator configured by the separation plates 20 (21 and 23), and the current collectors (30; 31, 33). However, the exemplary embodiment is not limited thereto and may also be applied to a state in which a plurality of unit cells is continuously stacked.

The membrane electrode assembly 10 includes a polymer electrolyte membrane configured to selectively pass hydrogen ions. An anode and a cathode are connected at both surfaces of the polymer electrolyte membrane. In addition, a fluid distributing layer is configured to transfer the reaction gas used in the electrochemical reaction to an electrode and discharge a product due to the electrochemical reaction. More detailed configuration and operation of the membrane electrode assembly 10 are known and the detailed description is omitted below. The separation plates 20 (21 and 23) are stacked at the side of the membrane electrode assembly 10.

The separation plates 20 (21 and 23) are stacked at the side of the membrane electrode assembly 10 and configured to structurally support the fuel cell stack 100. The separation plates 20 (21 and 23) include a cathode separation plate 21 stacked at one side of the membrane electrode assembly 10 and an anode separation plate 23 stacked at the other side of the membrane electrode assembly 10. The separation plates 20 (21 and 23) are also configured to supply the reaction gas or cooling water from the outside and also are configured to discharge the product such as water generated after the electrochemical reaction of the reaction gas and the like to the outside. The reaction gas may be applied by a fuel gas, an oxidant gas, or the like and supplied through the manifold 50.

The cathode separation plate 21 includes an oxidant gas channel formed at one side facing the membrane electrode assembly 10 and may be configured such that the oxidant gas containing oxygen flows into the oxidant gas channel through the manifold 50.

The anode separation plate 23 includes a fuel gas channel formed at one side facing the membrane electrode assembly 10 and may be configured such that the fuel gas containing hydrogen flows into the fuel gas channel through the manifold 50. The oxidant gas channel and the fuel gas channel may be implemented in various forms and the detailed drawing for the channels is omitted.

A gasket 232 may be configured to prevent the reaction gas from leaking in the manifold 311 and may be fabricated by a material including silicon-based, fluorine-based, olefin-based, and ethylene propylenediene monomer (EPDM) rubbers, a glass fiber-reinforced silicon sheet, or a teflon sheet. The gasket 232 may be formed of a corrosion resistant material such that it is not easily corroded. The gasket 232 may also be positioned relatively close to another constituent element so that the reaction gas does not leak.

The manifold 50 may be formed with the membrane electrode assembly 10, the cathode separation plate 21, and the anode separation plate 23 in a stack. In more detail, the manifold 50 may be formed as one passage configured to supply the reaction gas by stacking and connecting a manifold 101 of the membrane electrode assembly 10, a manifold 211 of the cathode separation plate 21, and a manifold 231 of the anode separation plate 23. Here, the manifold 101 of the membrane electrode assembly 10, the manifold 211 of the cathode separation plate 21, and the manifold 231 of the anode separation plate 23 may be disposed at an outer edge area, not a reaction gas area in which the electrochemical reaction with hydrogen and oxygen is caused.

The current collectors 30 (31 and 33) are stacked at the sides of the cathode separation plate 21 and the anode separation plate 23. The current collectors 30 (31 and 33) includes a cathode current collector 31 stacked at one side of the cathode separation plate 21 and an anode current collector 33 stacked at one side of the anode separation plate 23. In the cathode current collector 31 and the anode current collector 33, the manifolds 311 and 331 may be formed and configured to supply the reaction gas in a direction of the membrane electrode assembly 10.

A drawn tap 35 is formed at the current collectors 30 (31 and 33). An external wire may be electrically connected to the drawn tap 35 such that the electrical energy may be drawn out to the outside. The end plates 40 (41 and 43) are installed at each side of the cathode current collector 31 and the anode current collector 33. The end plates 40 (41 and 43) include a first end plate 41 connected at the side of the cathode current collector 31 while configured to apply a connection pressure and a second end plate 43 connected at the side of the anode current collector 33 while configured to apply a connection pressure. The end plates 40 (41 and 43) may secure and connect the membrane electrode assembly 10, the cathode current collector 31, and the anode current collector 33 to each other with a predetermined connection pressure while protecting the membrane electrode assembly 10, the cathode current collector 31, and the anode current collector 33.

Meanwhile, the cutoff blocks 60 (61 and 63) are located and configured to block a contact between the reaction gas and the current collectors 30 (31 and 33). The cutoff blocks 60 (61 and 63) are installed in the manifold 50. The cutoff blocks 60 (61 and 63) are installed and configured to prevent the corrosion generated when the reaction gas containing water is contacted with the current collectors 30 (31 and 33) made of a metal material.

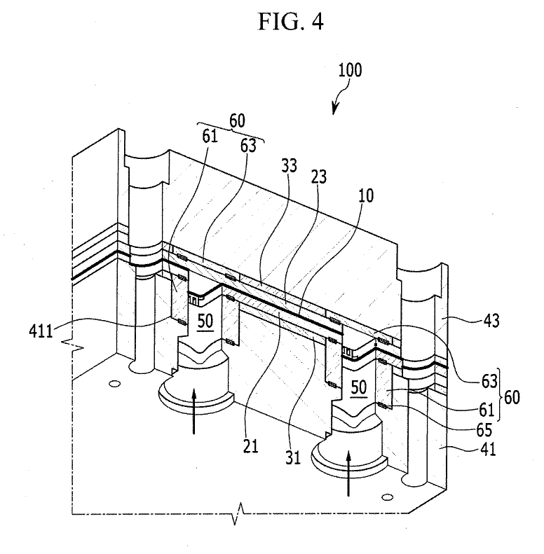

FIG. 4 is a cross-sectional view taken along line IV-IV of FIG. 1. As shown in FIG. 4, the cutoff blocks 60 (61 and 63) includes a first block 61 inserted into the manifold to block the contact between the reaction gas and the cathode current collector 31 and a second block 63 inserted into the manifold 50 configured to block the contact between the reaction gas and the anode current collector 33. A part of the side of the first block 61 is inserted and fixed in the end plate 40 in the manifold 50. In more detail, the first block 61 is formed in a column or polyhedral shape corresponding to a shape of the manifold 50 to be inserted and fixed in the end plate 41.

To install the first block 61, an insertion part 411 is formed at the first end plate 41. The insertion part 411 is formed at the manifold 413 formed at the first end plate 41. The insertion part 411 has a size larger than a diameter of the manifold 413 formed at the first end plate 41 to form a space in which the first block 61 may be seated. In the state where the first block 61 is inserted into the first end plate 41, a part of the cathode current collector 31 side protrudes to the outside of the surface of the first end plate 41. A protruding height of the first block 61 may protrude in a height corresponding to a thickness of the cathode current collector 31. This is to prevent the cathode current collector 31 from being exposed to the manifold 50 by the protruding portion of the first block 61. Accordingly, the reaction gas containing water is blocked from being contacted with the cathode current collector 31, such that it is possible to prevent the cathode current collector 31 from being corroded.

The first block 61 may be made of a non-metallic material to prevent corrosion due to the contact with the reaction gas containing water. Synthetic resins, polytetrafluoroethylene (PTFE), or the like may be selected as the non-metallic material, but it is not limited thereto and the first block 61 may be made of any non-metallic material that does not corrode when contacted with water.

Meanwhile, the gasket 65 may be installed between the first block 61 and the insertion part 411. The gasket 65 may be configured to prevent the reaction gas from being leaked in the manifold 50 and may be fabricated by any material selected from a material including silicon-based, fluorine-based, olefin-based, and ethylene propylenediene monomer (EPDM) rubbers, a glass fiber-reinforced silicon sheet, and/or a PTFE sheet. The gasket 65 may be formed and configured to resist corrosion and may be formed with another constituent element so that the reaction gas does not leak.

The second block 63 is inserted into the manifold 331 of the anode current collector 33. The second block 63 may be installed in a plate shape having a thickness corresponding to the thickness of the anode current collector 33. As described above, the second block 63 is inserted and fixed into the manifold 331 of the anode current collector 33 such that the reaction gas moving in the manifold 50 can be blocked from being contacted with the anode current collector 33. The second block 63 is configured to block the reaction gas from contacting the anode current collector 33 and configured to prevent the corrosion. The second block 63 may be formed of a non-metallic material such as synthetic resin, polytetrafluoroethylene (PTFE), or the like having excellent corrosion resistance.

As described above, during operation of the fuel cell, the reaction gas moving in the manifold does not directly contact the current collectors 30 (31 and 33). Thus, the current collectors 30 (31 and 33) may be prevented from being corroded by the water included in the reaction gas.

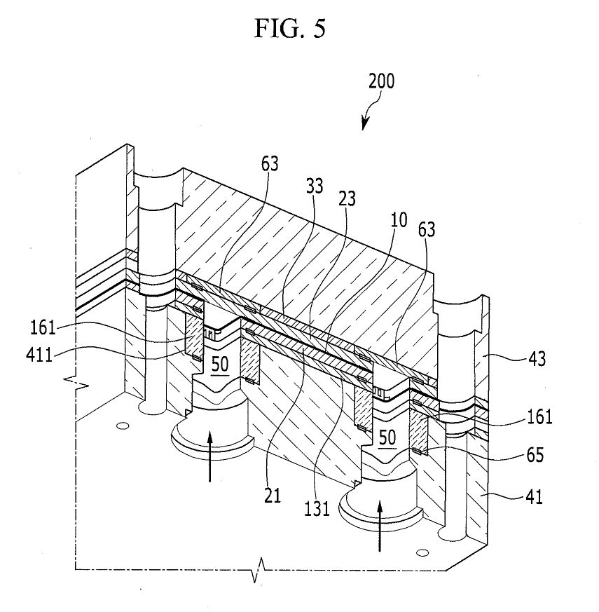

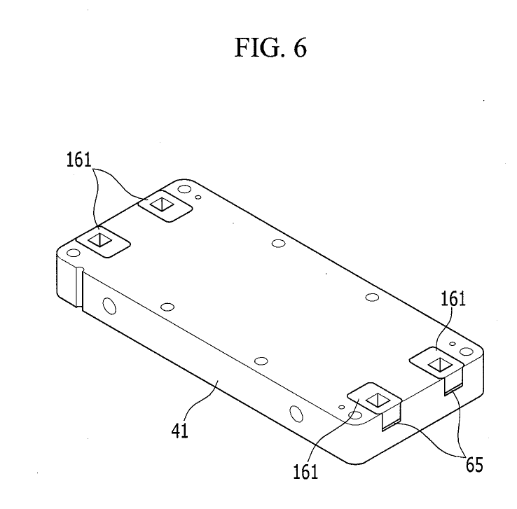

FIG. 5 is a cross-sectional view schematically showing a state in which a first block is installed in a fuel cell stack 200 according to a second exemplary embodiment of the present disclosure and FIG. 6 is a diagram schematically showing a state in which a first block is inserted into a first end plate according to the second exemplary embodiment. The same reference numerals as FIGS. 1 to 4 mean the same members having the same function. Hereinafter, the detailed description of the same reference numerals is omitted.

As shown in FIGS. 5 and 6, a fuel cell stack 200 according to the second exemplary embodiment includes a first block 161 inserted into the manifold 50 to separate the exposed portion to the manifold 311 of the cathode current collector 131 from the first end plate 41 and a second block 63 inserted into the manifold 50 to block the contact between the anode current collector 33 and the reaction gas. The first block 161 may be formed in a polyhedral or cylinder shape to be inserted into the insertion part 411 formed in the first end plate 41. In the first block 161, a protruding portion to the cathode current collector 31 side of the first end plate 41 is not provided while being inserted into the insertion part 411. In this case, the cathode current collector 131 further extends to a portion in which the first block 61 is installed such that a part of the cathode current collector 131 may be exposed in the manifold 50. The first block 161 may be made of a non-metallic material such as synthetic resins, polytetrafluoroethylene (PTFE), or the like. The first block 161 is made of the non-metallic material to maintain the first end plate 41 and the cathode current collector 131 to be separated from each other with a predetermined distance in the manifold 50. That is, in the cathode current collector 131 and the first end plate 41 which are made of the metallic material, the exposed portions to the manifold 50 are separated from each other by the first block 161. Accordingly, it is possible to prevent the corrosion from being progressed by the electrical conduction between different metals in the manifold 50.

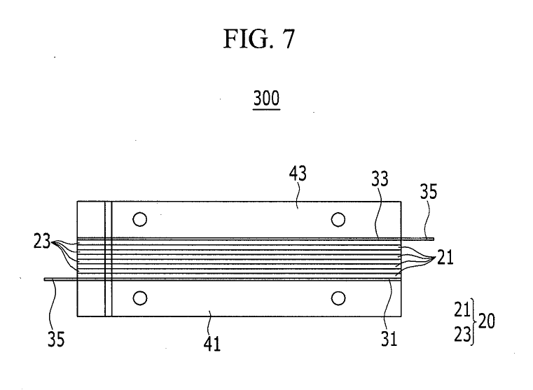

FIG. 7 is a side view schematically showing a fuel cell stack according to a third exemplary embodiment of the present disclosure. The same reference numerals as FIGS. 1 to 6 mean the same members having the same function. Hereinafter, the detailed description of the same reference numerals is omitted. As shown in FIG. 7, a fuel cell stack 300 according to the third exemplary embodiment has a structure including a plurality of electricity generators. That is, the plurality of electricity generators including a membrane electrode assembly, a cathode separation plate 21 stacked at one side of the membrane electrode assembly, and an anode separation plate 23 stacked at the other side of the membrane electrode assembly may be stacked. By the above configuration, much higher voltage may be generated in the fuel cell stack 300 during operation of the fuel cell.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell stack, comprising:
a membrane electrode assembly (“MEA”);
separation plates sandwiching and contacting both sides of the MEA;
current collectors sandwiching both sides of the separation plates, the current collectors configured to conduct electrical energy to an outside circuit;
first and second end plates sandwiching opposite sides of the current collectors and configured to apply a connecting pressure to the current collectors;
manifolds formed to pass through the MEA, at least one of the separation plates, at least one of the current collectors, and at least one of the end plates, the manifolds configured to fluidly communicate reaction gas; and
cutoff blocks inserted into a portion of the end plates forming the manifolds, the cutoff blocks configured to electrically separate the current collectors and the end plates from a passage in which the reaction gas is circulated.

2. The fuel cell stack of claim 1, wherein the current collectors include a cathode current collector adjacent to the first end plate and an anode current collector adjacent to the second end plate, and wherein the cutoff blocks include a first block inserted into the portion forming the manifold of the first end plate and protruding to a portion forming the manifold of the cathode current collector configured to block the contact between the reaction gas and the cathode current collector and a second block inserted into a portion forming the manifold of the anode current collector adjacent to the second end plate configured to block contact between the reaction gas and the anode current collector.

3. The fuel cell stack of claim 2, wherein the first block is formed of a non-metallic material.

4. The fuel cell stack of claim 2, wherein the first block is formed in a polyhedral or cylinder shape with a through-hole connection with the manifold.

5. The fuel cell stack of claim 4, wherein the first block is formed of a non-metallic material.

6. The fuel cell stack of claim 2, wherein the first block is formed so that a portion protruding to the cathode current collector side is the same as a thickness of the cathode current collector.

7. The fuel cell stack of any one of claim 6, wherein the first block is formed of a non-metallic material.

8. The fuel cell stack of claim 7, wherein the first block is formed of the non-metallic material including synthetic resins or polytetrafluoroethylene (PTFE).

9. The fuel cell stack of claim 2, wherein in the first end plate, an insertion part into which the first block is inserted is formed at the portion with the manifold and a gasket is installed between the insertion part and the first block.

10. The fuel cell stack of claim 2, wherein the second block contacts the surface of the second end plate.

11. The fuel cell stack of claim 10, wherein the second block is formed of a non-metallic material.

12. The fuel cell stack of claim 11, wherein the second block is formed of the non-metallic material including synthetic resins or polytetrafluoroethylene (PTFE).

13. The fuel cell stack of claim 1, wherein the current collectors include a cathode current collector adjacent to the first end plate and an anode current collector adjacent to the second end plate, and wherein the cutoff blocks include a first block inserted into a portion forming the manifold of the first end plate configured to separate the cathode current collector from the first end plate and a second block inserted into a portion forming the manifold of the anode current collector adjacent to the second end plate configured to block contact between the reaction gas and the anode current collector.

14. The fuel cell stack of claim 13, wherein the first block contacts the surface of the cathode current collector.
